(19) United States
(12) Patent Application Publication
(10) Pub. No.: US 2017/0305110 A1
(43) Pub. Date: Oct. 26, 2017

(54) Manufacture of a textile or foil-based sheet body of multicompartment structure

(71) Applicant: UNIVERSITÄT STUTTGART, Stuttgart (DE)

(72) Inventors: Fabian SCHMID, Esslingen (DE); Werner SOBEK, Stuttgart (DE); Walter HAASE, Hildrizhausen (DE)

(21) Appl. No.: 15/516,227

(22) PCT Filed: Oct. 16, 2015
(86) PCT No.: PCT/EP2015/002053

§ 371 Date: Mar. 31, 2017

(30) Foreign Application Priority Data
Oct. 17, 2014 (DE) 10 2014 015 376.2

(51) Int. Cl. B32B 5/26; D03D 11/00; B32B 5/06; B60R 21/233

(52) U.S. Cl. CPC B32B 5/26; B60R 21/233; D03D 11/00; B32B 5/06; B32B 2255/02; B32B 2255/26; D06N 2209/128; B32B 2605/003

(57) ABSTRACT

The invention relates to a method of manufacturing a textile or foil-based sheet body which has a multicompartment structure, wherein the textile or foil-based sheet body is an at least two-ply stitched woven fabric, an at least two-ply fused, welded or adhered foil, a combination thereof and/or a one-piece woven (OPW) fabric, comprising the steps of forming auxiliary channels (2) around the shape of the outer contour of the compartments; filling the auxiliary channels (2) with a mobile silicone-based sealant comprising an additive; and curing the sealant. The invention further relates to the multicompartment vessels obtained by the method of the invention.

The invention relates to a method of manufacturing a textile or foil-based sheet body which has a multicompartment structure, wherein the textile or foil-based sheet body is an at least two-ply stitched woven fabric, an at least two-ply fused, welded or adhered foil, a combination thereof and/or a one-piece woven (OPW) fabric, comprising the steps of forming auxiliary channels (2) around the shape of the outer contour of the compartments; filling the auxiliary channels (2) with a mobile silicone-based sealant comprising an additive; and curing the sealant. The invention further relates to the multicompartment vessels obtained by the method of the invention.

Textile or foil-based sheet bodies have many and varied industrial applications. One area of application is in, for example, airbags, as a device to provide protection in the passenger compartment in the event of a vehicle collision. Airbags consisting of one-piece woven (OPW) material may be configured by means of floating threads and seams into the desired shape (when in the activated state and/or gas filled). The OPW material consists of two or more plies which are unitary (i.e. integral and/or single-ply) in those regions which are designed to support and seal and which do not unfold. Generally, complete tightness against fluid egress is undesired in these places, since under load the gas fill is supposed to distribute across the various compartments, of a side-impact airbag for example, in a resiliently elastic manner.

Another area of application for textile or foil-based sheet bodies is as a sheet body having numerous individual compartments to be filled with a fluid, for example water, to flow therethrough. Here, in the integral places of the OPW material where there is a transition to a structure having two or more plies, sufficient tightness is desired. Instead of an OPW material there may also be used at least two-ply foils or textile plies which are connected in other ways and whereinto auxiliary channels have been incorporated.

Adhesives or overstitched seams, for example, have hitherto been used to seal off the places between the compartments. Either solution, in addition to requiring more time and/or more material, has performance disadvantages. Adhesive seals in particular may predetermine breaking points because of their unfavourable mechanical properties as the compartments come under stress as a result of being filled with a fluid.

EP 1 377 499 B1 relates to a flexible vessel for transporting a large volume of liquid, fabricated from heat-resistant OPW fabric having an outer facial thermoplastic coating formed of, inter alia, silicone polymers by thermal melting, in the course of which the coating bonds facially to the core fabric. The purpose in EP 1377499 is to obtain a buoyant and hence watertight container.

WO 2012/126614 A1 describes objects formed from OPW fabric whereinto compartments for filling with air or other fluids have been formed, while a coating is provided to seal off the textile sheet bodies.

The problem addressed by the present invention is therefore that of achieving improved/stabler sealing of compartment boundaries in a simple and reliable manner. Fluidtight compartmented structures for filling with fluids are to be achieved in particular. Fluids for the purposes of the present invention may be liquid, such as water; viscous, such as gels, glycerol or petroleum; dispersed, such as water-sand mixes, mortar or render; semi-solid, such as dust, salts or fine sand; or gaseous, such as air, nitrogen, mixtures of oxygen and nitrogen, noble gases or carbon dioxide.

This sealing is achieved in the present invention by providing, for example, a separately topstitched auxiliary channel in the fabric. This form of sealing is further also employable in at least two-ply sheet bodies, as formed from fabrics and/or films for example, where stitching or fusing foils or welding is used to produce boundaries of compartments.

It has now been found that, surprisingly, the problem defined above is solved by the precise sealing of the compartment boundaries (where two or more fabric plies meet), via separately topstitched auxiliary channels, with a suitable sufficiently fluent silicone material as sealant.

The invention accordingly provides by claim 1 a method A method of manufacturing a textile or foil-based sheet body which is fluidtight on filling with fluids and has a multicompartment structure (1), wherein the textile or foil-based sheet body is an at least two-ply stitched woven fabric, an at least two-ply fused, welded or adhered foil, a combination thereof and/or a one-piece woven (OPW) fabric, comprising the steps of forming auxiliary channels (2) at least partly, generally fully, around the shape of the outer contour of the compartments, i.e. at the seams or joins; filling the auxiliary channels (2) with a mobile silicone-based sealant comprising an additive; and curing the sealant. In the present invention, auxiliary channels (2) integrated in a textile or foil-based sheet body (1) of multicompartmented structure, along a compartment (1), are filled with a sealant against fluids, using a silicone-based sealant comprising an additive in such an amount that the as-prepared sealant fills the auxiliary channels essentially completely and within an appropriate period cures into a stable and flexible barrier mutually sealing the compartments along the seam or join.

Dependent claims define further subjects of the present invention.

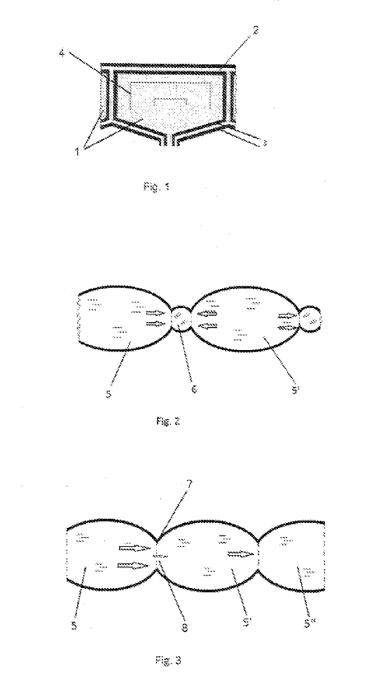

FIG. 1 shows the schematic construction of a compartment 1 sealed off by auxiliary channels 2.

FIG. 2 shows the design which the invention provides for the sheet body of multicomparmented structure, to illustrate that fluid can no long pass from compartment 5 into compartment 5′ (or else vice versa, when the confining pressure is applied differently).

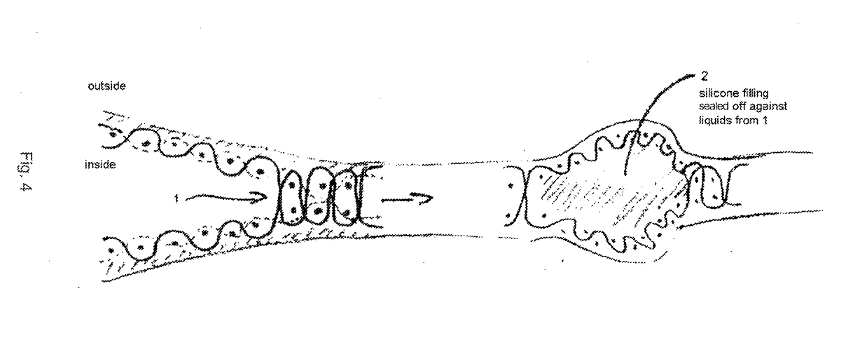

FIG. 3 shows the existing solution in the prior art, where fluid is able to pass into the other compartments.

FIG. 4 shows a sectional diagram of an OPW fabric at the transition region from the single-ply to the multi-ply part and the solution which the invention provides to the tightness problem at the place concerned (detailed view of FIG. 2 at around reference numeral 6 insofar the material is OPW).

Depending on the compartment material, the textile or foil-based sheet body may possibly also require some additional facial sealing toward the outside. Such coatings, for example with silicone, of sheet bodies having compartments, e.g. airbags, are known. In the case of OPW materials, however, it is desirable to have some sealing at the conjunction in the fabric as well as any facial sealing present on the outside surface (cf. sectional drawing in FIG. 4). No fewer than 4 fibrous plies are conjoined in the OPW material. Small holes form at the conjunction and lead to liquids and gases penetrating through into the fabric plane (cf. reference numeral 1 in FIG. 4). In some cases, the exit of gas at this place is desired in certain circumstances, for example when the OPW material is employed in certain designs of airbags, in order that the cushioning characteristics of this airbag may be controlled. In the case of a fluidtight fluid containment vessel, however, it is more the case of some sealing being required in this place. Three ways are known to possibly solve this tightness problem in the fabric plane:
1. Sealing from the inside: this is more likely to be successful with large structures; with fabrics typically from 0.5 to 10 cm in thickness, however, this is scarcely achievable in an efficient manner; imported coatings will cause parts of the container to stick together, rendering them no longer usable; with containers through which there is a flow of liquids there is additionally a risk that the coating will be washed off over time.
2. Welding/fusing the outer contour: the dimensions are again the issue here; fusing/welding at first appears to be successful; but when the flexible containers then come to be used, the stiff welded/fused seams will break in turn and lead to leaks in service.
3. Adhering the outer contour: this method is possible, but burdensome, since every time it is necessary to make a mould having the corresponding outer contour, into which the made-up textile is placed, the adhesive is applied and curing can take place.

The invention, then, provides a solution where, in short, an auxiliary channel is formed around the shape of the outer contour of compartments in multi-ply sheet bodies, i.e. at the compartment joints, and a suitably mobile silicone-based sealant is filled into the channel and cured.

The use of known mobile silicone-based sealants of comparatively low viscosity carries the risk of insufficient curing on their part. If liquid silicone-based sealants of comparatively high viscosity which are capable of rapid and thorough curing are used, their high surface tension and the resulting friction mean that they can only be introduced into a limited, excessively small region.

The term “mobile” is to be understood in the context of the present invention as meaning a liquid having a dynamic viscosity at room temperature (20° C.) in the range from 500 to 10 000 mPas (DIN 53018).

The silicone-based sealant used is a curable silicone material which is additized with an additive to enhance the fluency of the curable silicone material and thereby enable simple filling of the auxiliary channels along the compartment boundaries (with minimal or no pressure being applied, for example). Using this sealant, which is of low viscosity by virtue of additives, enables the compartments to be filled without high or damaging pressure having to be employed to force it in.

The silicone-based sealant selected has added to it an additive to lower its surface tension, ensuring the attainment of a viscosity sufficient for filling operations and nonetheless the taking place of a cure which will be adequate in the foreseeable future. That is, the mixture sets, and changes into a solid state, after an extended processing life period.

The additive is preferably a lower alcohol, preferably a linear and/or branched C1-C5 alcohol, more preferably a propanol or propyl alcohol (i.e. n-propanol and/or isopropanol).

The silicone-based sealant used may preferably be a material which essentially is based on polysiloxanes and crosslinks through orthosilicate esters in the presence or absence of a catalyst by elimination of an alcohol, generally ethanol. Concurrently or thereafter, the viscosity is suitably lowered by admixing the additive. Without wishing to be tied to any one theory, it is believed that a lower alcohol as described above will keep the molecules of the polysiloxane and of the orthosilicate ester sufficiently far apart to achieve an advantageous low viscosity for the filling step and to adjust the reactivity of the reactants such that the silicone-based sealant has sufficient time, such as 10 to 90 min, preferably 20 to 70 min, especially 30 to 60 min to cure in the auxiliary channels and seal off the single-ply places between the compartments. This is surprising in that the HO-bearing alcohol might actually have been expected to disrupt the setting. The amount of additive depends on the geometric dimensions of the auxiliary channels. As a result, the amount of additive is adjustable according to the geometric dimensions of the auxiliary channels. The viscosity to be achieved should enable easy filling of long auxiliary channels or auxiliary-channel systems without application of external pressure. A person skilled in the art is readily able to determine the optimum by testing.

This creates the prerequisites for the industrial implementation of a rapid and efficient automatic process for filling the auxiliary channels at the joints.

The sealant sets after a certain residence time, for example after 30-40 min. The cured sealant preferably has a Shore A hardness of <10, preferably 0. The fumes created in the course of the curing process have to be able to escape through the compartment material, making it preferable to use efficiently diffusion-capable compartment materials. This is ensured by one OPW fabric or combinations of fabric or fibrous nonwoven web and foils. In the case of foils as sheet bodies, diffusion capability to the appropriate standard has to be ensured through, for example, precisely chosen properties of the material, or needling. It is advantageous to employ OPW fabrics whose geometry is capable of flexible adaptation to the service and/or transportation conditions. Fabric or foil is required to have a diffusion capability for molecular sizes up to 0.1 nm³.

The fabric may consist of polymer, for example fibres of polyamide, such as nylon, polyester, PEEK, PEKK, aramid, carbon or polyolefin. It may also consist of inorganic fibres, such as glass, rockwool, asbestos or metal fibres, such as steel or silver fibres. The sheet body may further consist of polymer foils, of the abovementioned polymers for example, metal foil, paper, fibrous nonwoven web or combinations. Combinations of the aforementioned fabrics and non-fabrics are also possible.

In the case of fabrics, the filament linear density of the yarn used may be in the range from 1 to 3 dtex. However, it may also be >5 dtex in other embodiments. Yarn linear density may be in the range from 200 to 500 dtex, in particular 315 to 400 dtex.

The auxiliary channels may have a height amounting to from 0.01 to 50 times the sheet body thickness measured without application of force. The width of the auxiliary channels may be from 0.1 to 200 times the thickness of the sheet body. The fabric thickness for fluids is in the range from 1 to 0.1 mm, preferably in the range from 0.8-0.2 mm, in particular in the range from 0.5 to 0.25 mm. For other purposes, thicknesses of 0.01 to 20 mm or 0.05 to 10 mm or 0.2 to 5 mm, for example 0.4 to 2 mm, are appropriate.

In principle, the size of the silicone-filled auxiliary channel should be made such that, on charging the compartments with a fluid, this fluid does not pass from one compartment via the joint into any other compartment when exposed to the customary load in service, cf. FIG. 2. The silicone-filled auxiliary channels 6 do not allow a fluid to pass from compartment 5 into compartment 5′. In contradistinction thereto, the prior art does allow fluid to pass from compartment 5 into compartment 5′, 5″, etc. depending on the confining pressure applied, cf. FIG. 3.

The method of the present invention provides a way to fill compartments having small diameters, for example tubelike bodies 5-10 mm in diameter and 2 to 3 m in length. This creates storage containers for liquid products that are made of textile materials. The advantage of manufacturing storage containers comprising fabrics resides in the scope for a precise manipulation of container geometry by the weaving process. Reusable and geometrically optimizable containers of high value are obtainable in this way.

The objects thus obtained according to the present invention, i.e. appropriately sealed compartment structures, are useful in general for fluid containment, transportation or storage. Use as solar collectors is also possible. Civil engineering applications as insulation or soundproofing material are conceivable. In these applications, the materials are transported in the rolled-up state and installed on site. This serves to reduce mass consumption and consumption of resources. In addition, the lower masses allow simplified constructions, for example as building exterior elements. The production of design vessels having unusual geometries may be of interest to interior decorators. In biomedical engineering, the development of new devices for the stockholding of medicinal products or of nutrient solutions is conceivable.

### LIST OF REFERENCE SIGNS

1 compartment in a single-ply/multi-ply sheet body for filling with a fluid, such as water or air
2 auxiliary channel which has been filled with sealant in the manner of the invention
3 orbital stitching/conjoining of fabric plies to form a channel for sealing
4 tacking or topstitching
5 compartment with fluid
6 silicone barrier in auxiliary channel
7 joint in multi-ply part between single-ply compartment regions 5
8 passage from left-hand compartment 5 to right-hand compartment 5′ etc. possible (or else vice versa, depending on the confining pressure applied)

1. A method of manufacturing a textile or foil-based sheet body which is fluidtight on filling with fluids and has a multicompartment structure, wherein the textile or foil-based sheet body is an at least two-ply stitched woven fabric, an at least two-ply fused, welded or adhered foil, a combination thereof and/or a one-piece woven (OPW) fabric,
comprising the steps of forming auxiliary channels at least partly around the shape of the outer contour of the compartments; filling the auxiliary channels with a mobile silicone-based sealant comprising an additive; and curing the sealant.

2. A method according to claim 1 wherein the additive used is a lower alcohol.

3. A method according to claim 2 wherein the lower alcohol used is a C1-C5 alcohol, preferably a propyl alcohol.

4. A method according to claim 1 wherein the sealant cures for not less than 10 min after the step of filling.

5. A method according to claim 4 wherein the sealant has a Shore A hardness of <10 after curing.

6. A textile or foil-based article wherein the textile or foil-based sheet body is an at least two-ply stitched woven fabric, an at least two-ply fused, welded or adhered foil, a combination thereof and/or a one-piece woven (OPW) fabric, endowed with sealant-filled auxiliary channels around the shape of the outer contour of the compartments, obtainable according to claim 1.
